(19) United States
(12) Patent Application Publication
(10) Pub. No.: US 2017/0316900 A1
(43) Pub. Date: Nov. 2, 2017

(54) ROTATING CONTACT APPARATUS FOR A SWITCH

(71) Applicant: Eaton Electrical IP GmbH & Co. KG, Schoenefeld (DE)

(72) Inventors: Louis A.G.M. Hemmer, Hengelo (NL); Hans-Juergen Sduntzig, Koenigswinter (DE)

(21) Appl. No.: 15/525,291

(22) PCT Filed: Nov. 6, 2015
(86) PCT No.: PCT/EP2015/075894

§ 371 Date: May 9, 2017

(30) Foreign Application Priority Data
Nov. 11, 2014 (DE) 10 2014 116 400.8

(51) Int. Cl. H01H 19/04; H01H 19/10; H01H 3/40

(52) U.S. Cl. CPC H01H 19/04; H01H 3/40; H01H 19/10

(57) ABSTRACT

A rotating switch contact apparatus has an apparatus housing; a contact housing; a housing bearing provided in the contact apparatus housing, the housing being rotatably mounted in the bearing; and a contact bridge mounted in the housing, rotating with the latter and having, at each end, a stationary mating contact receptacle, receptacles protruding from housing openings so the receptacles engage stationary mating contacts during contact housing rotation and may produce electrical contact between stationary mating contacts via the contact bridge. At least one spring terminal is arranged between the housing and bridge, which is resiliently mounted in the housing approximately perpendicular to the apparatus rotational plane. The contact housing is approximately cylindrical and at least partially has, on its lateral surface, a gearwheel section, and has an opening through which the gearwheel section projects, so the housing is rotationally movable for contact opening or closing between stationary mating contacts and receptacles via a gearwheel engaging in the gearwheel section.

### CROSS-REFERENCE TO RELATED APPLICATIONS

This application is a U.S. national stage application under 35 U.S.C. §371 of International Application No. PCT/EP2015/075894, filed on Nov. 6, 2015, and claims benefit to German Patent Application No. DE 10 2014 116 400.8, filed on Nov. 11, 2014. The International Application was published in German on May 19, 2016, as WO 2016/075039 A1 under PCT Article 21(2).

### FIELD

The invention relates to a rotating contact apparatus for a switch.

### BACKGROUND

Twin-contact apparatuses comprising parallel contacts are often used for switches, in particular circuit breakers, in order to increase the contact force during a high current flow and thus prevent contacts becoming detached and interrupted contact occurring. Furthermore, long opening distances are required for the contacts, especially in the case of circuit breakers for high currents, in order to make it easier to extinguish any arcs arising when opening the contacts, for example. However, long contact opening distances often require large switch housings. The space required for a large opening distance can be reduced at least to some extent by a rotating contact apparatus. A switch comprising a rotating contact apparatus is known from US patent publication US2014/0091062A1, for example.

A rotating contact apparatus having the features of the preamble of claim 1 is known from U.S. Pat. No. 5,945,650. Other rotating contact apparatuses are known from U.S. Pat. No. 3,632,935, international publication WO 2014/170528A1 and German patent application DE 10 2011 077 883 A1. However, the rotating contact apparatuses disclosed in these publications are in some cases extremely bulky and therefore require a relatively large installation space.

### SUMMARY

An aspect of the invention provides a rotating contact apparatus for a switch, comprising: a contact apparatus housing; a contact housing; a bearing for the contact housing, provided in the contact apparatus housing, the contact housing being mounted in the bearing so as to rotate about a rotation axis; a contact bridge, mounted in the contact housing, which rotates with the housing and includes, at each of an end thereof, a receiving portion for one or more stationary mating contacts, wherein the receiving portions protrude from corresponding openings in the contact housing to such an extent that the receiving portions engage with the stationary mating contacts during rotation of the contact housing, configured such that electrical contact may be produced between the stationary mating contacts via the contact bridge, wherein at least one spring terminal is arranged between the contact housing and the contact bridge such that the contact bridge is resiliently mounted in the contact housing approximately perpendicular to a rotational plane of the contact apparatus, wherein the contact housing is approximately cylindrical, wherein the contact housing includes, on at least part of a lateral surface thereof, a gearwheel portion, and wherein the contact apparatus housing includes an opening through which the gearwheel portion projects, such that the contact housing can be caused to rotationally move to open or close the contacts between the stationary mating contacts and the receiving portions using a gearwheel engaging in the gearwheel portion.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a perspective view of an embodiment of a rotary switch comprising a rotating contact apparatus according to the invention;

FIG. 2 is a perspective view of a partial section through the rotary switch from FIG. 1;

FIGS. 3 and 4 are perspective views of a further partial section through the rotary switch from FIG. 1, shown in an off position (FIG. 3) and an on position (FIG. 4); and

FIG. 5 is a perspective view of a section through the contact housing for the rotary switch from FIG. 1.

### DETAILED DESCRIPTION

An aspect of the present invention provides a compact rotating contact apparatus for a switch.

One embodiment of the invention relates to a rotating contact apparatus for a switch, comprising a contact apparatus housing and a contact housing, a bearing for the contact housing which is provided in the contact apparatus housing, the contact housing being mounted in the bearing so as to rotate about an axis of rotation, a contact bridge which is mounted in the contact housing, rotates with said housing and has, at each of the ends thereof, a receiving portion for a stationary mating contact, the receiving portions protruding from corresponding openings in the contact housing to such an extent that said receiving portions engage with the stationary mating contacts during rotation of the contact housing and electrical contact may be produced between the stationary mating contacts via the contact bridge, and at least one spring terminal which is arranged between the contact housing and the contact bridge such that the contact bridge is resiliently mounted in the contact housing approximately perpendicular to the rotational plane of the contact apparatus. According to the invention, in order to permit a more compact design of this rotating contact apparatus, the contact housing is designed to be approximately cylindrical and has, on at least part of the lateral surface thereof, a gearwheel portion, and the contact apparatus housing has an opening through which the gearwheel portion projects, with the result that the contact housing can be caused to carry out a rotational movement for opening or closing the contacts between the stationary mating contacts and the receiving portions by means of a gearwheel (a mechanism which does not form part of the contact apparatus) engaging in the gearwheel portion. The fact that a gearwheel portion is provided on the lateral surface of the cylindrical contact housing means that the rotating contact apparatus can be designed to be more compact, since the contact apparatus housing comprising the bearing for the contact housing can be designed to be approximately rectangular, and the mechanism for rotating the contact housing can be arranged on a narrow side of the rectangular contact apparatus housing above the rotating contact apparatus, with the result that the total extension of the rotating contact apparatus comprising a drive mechanism in the axis of rotation can be significantly smaller than the extension perpendicular to the axis of rotation. In summary, in the present invention, the arrangement of the gearwheel portion on the lateral surface of the cylindrical contact housing in particular makes it possible to design significantly more compact rotating contact apparatuses, in which a drive mechanism can be arranged above the contact apparatuses, as a result of which the extension of the arrangement as a whole in the axis of rotation is also significantly smaller than in the case of rotating contact apparatuses comprising a drive mechanism located in front of or behind said apparatuses in the axis of rotation.

In particular, the contact apparatus housing may comprise two housing half-shells, the bearing may be formed in at least one of the two housing half-shells, and at least one of the two housing half-shells may comprise the opening for the gearwheel portion of the contact housing on a side approximately perpendicular to the axis of rotation. As a result, this provides a compact contact apparatus housing which can be produced with little technical outlay.

The contact housing may comprise two almost identically formed housing shells, which each comprise plug-in connections and a bearing for the contact bridge and the at least one spring terminal for assembling the contact housing. This makes it easier to assemble the contact apparatus.

The contact bridge may comprise an approximately rectangular middle part, on each short side of which a receiving portion for a stationary mating contact is provided. In particular, the contact bridge may be manufactured in one piece from sheet metal, by die cutting for example.

The receiving portions for the stationary mating contacts may each be designed as claw-shaped mating contact receiving parts and may each be aligned such that the opposing claws thereof are located on different planes that are parallel with the rotational plane of the contact apparatus.

A further embodiment of the invention relates to a rotary switch comprising a rotating contact apparatus according to the invention and as described in this document.

Further advantages and possible applications of the present invention are explained in the following description in conjunction with the embodiments illustrated in the drawings.

The terms and associated reference numerals used in the list of reference numerals reproduced below are used in the description, claims, abstract and drawings.

Identical components, or components having the same function or associated functions may be assigned the same reference numerals in the description below. Absolute values are only given below by way of example and should not be construed as limiting the invention in any way.

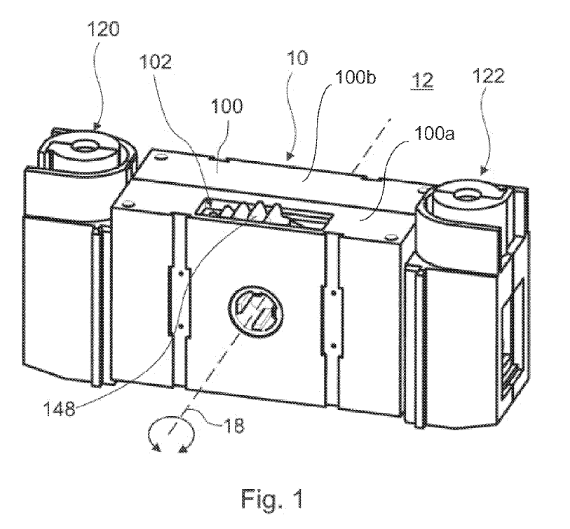

FIG. 1 shows a rotary switch 12 comprising two contact connections 120 and 122 for attaching supply lines and a rotating contact apparatus 10 for closing and interrupting an electrical connection between the two contact connections 120 and 122. The contact apparatus housing 100, which consists of two housing half-shells 100a and 100b, of the contact apparatus 10 comprises an opening 102 in the front housing half-shell 100a for moving the contact element of the apparatus 10. A gearwheel portion 148, by means of which the contact element can be caused to carry out a rotational movement together with a gearwheel of a mechanism, projects through the opening to open or close the contacts of the contact element. The front housing half-shell 100a also comprises, as shown in FIG. 1, an opening in which a shaft of the contact element, which is able to rotate about an axis of rotation 18, can be mounted.

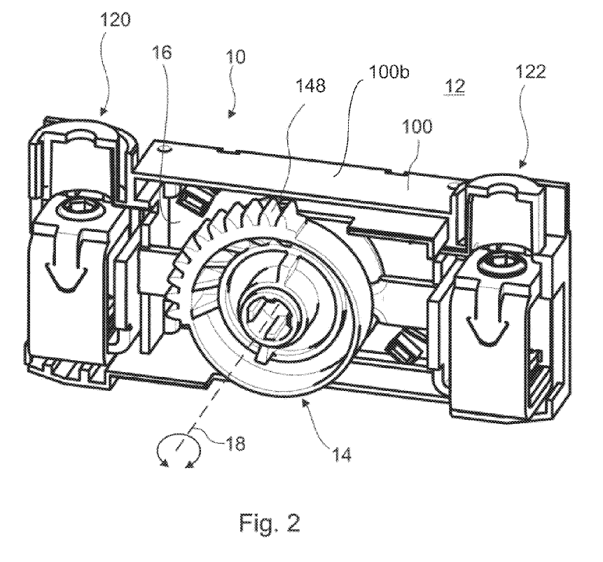

FIG. 2 shows the internal structure of the contact apparatus 10 of the rotary switch 12: a bearing 16 for a contact housing 14 of the rotating contact element of the contact apparatus 10 is provided in the rear housing half-shell 100b of the contact apparatus housing 100. The approximately cylindrical contact housing 14 is mounted in the bearing 16 of the housing 100 so as to rotate about the axis of rotation 18. A bearing for the contact housing 14 may also be provided in the front housing half-shell 100a. In this respect, the front housing half-shell 100a may also be formed so as to be identical to the rear housing half-shell 100b at least in part.

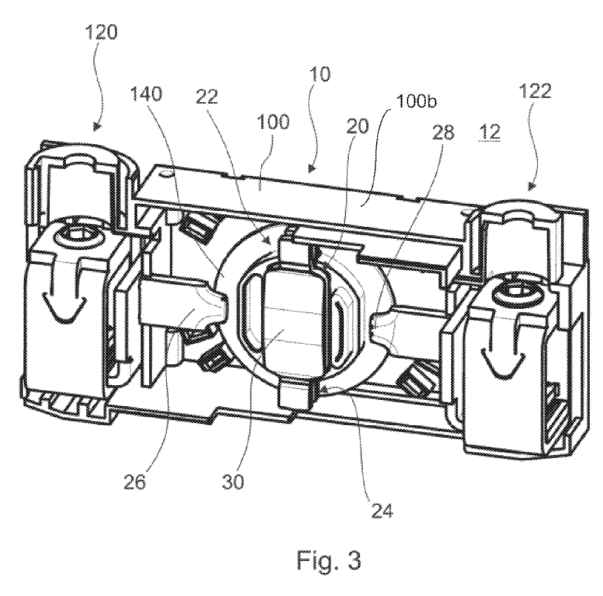

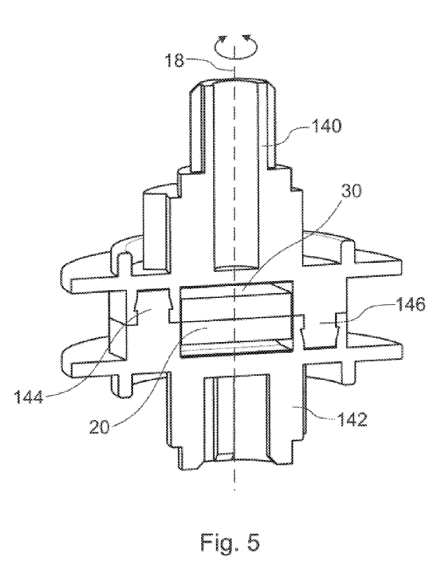

FIG. 3 shows the internal structure of the contact housing 14, which, as shown in FIG. 5, comprises two in particular identical housing shells 140 and 142 made from electrically insulating plastics material, said shells being able to be interlocked by means of plug-in connections 144 and 146 for the housing 14. A bearing for an electrically conductive contact bridge 20 is provided between the two interlocked shells 140 and 142, said bridge providing an electrical connection between the two contact connections 120 and 122. At least one spring terminal 30 is arranged between the contact bridge 20 and one of the housing shells 140 or 142, as a result of which the contact bridge 20 is resiliently mounted approximately perpendicular to the rotational plane of the contact apparatus 10 and the contact housing 14. The spring terminal is specifically intended to compensate for any tolerances, such as, for example, manufacturing tolerances associated with the rotating contact apparatus 10 and tolerances due to plastic deformation of the rotating contact apparatus 10 which may occur in operation.

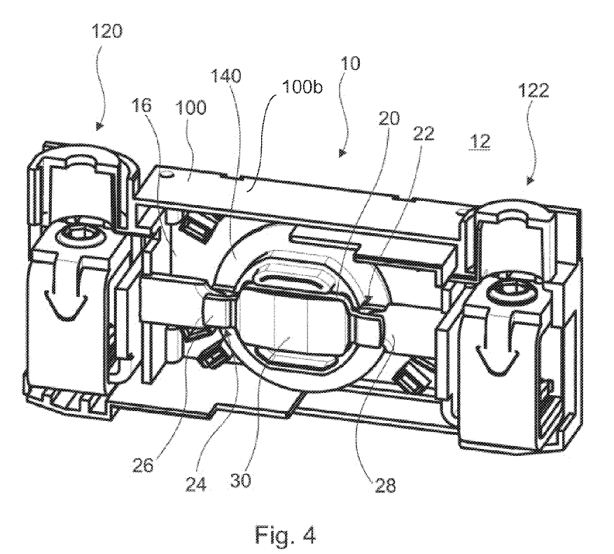

As shown in FIGS. 3 and 4, the contact bridge 20 comprises an approximately rectangular middle part, a claw-shaped receiving part 22, 24 for the stationary mating contacts 26, 28 being provided on each short side of said middle part. In this case, the receiving parts 22, 24 are aligned such that the opposing claws thereof are located on different planes that are in parallel with the rotational plane of the contact apparatus.

By rotating the contact housing 14 by means of the gearwheel portion 148 projecting through the opening 102 from an off position (FIG. 3) to an on position (FIG. 4) of the rotary switch 12, the claw-shaped receiving parts 22, 24 are pushed over the respective stationary mating contacts 26, 28 (as shown in FIG. 4) such that the mating contacts 26, 28 are located between the claws of the receiving parts 22, 24. In this case, the claw-shaped receiving parts 22, 24 are dimensioned and formed such that an electrical contact is produced when a stationary mating contact 26, 28 is pushed into said receiving parts and such that the contact connections 120, 122 electrically connected to the stationary mating contacts 26, 28 are electrically connected via the contact bridge 20. It is also easier to engage the stationary mating contacts 26, 28 in the claw-shaped receiving parts 22, 24 on account of the at least one spring terminal 30 and the fact that the stationary mating contacts 26, 28 are blade-shaped.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### REFERENCE NUMERALS

10 rotating contact apparatus
100 contact apparatus housing
100a front housing half-shell for the contact apparatus housing 100
100b rear housing half-shell for the contact apparatus housing 100
102 drive opening
12 rotary switch
120 contact connection
122 contact connection
14 contact housing
140 contact housing shell
142 contact housing shell
144 housing shell plug-in connection
146 housing shell plug-in connection
148 gearwheel portion
16 contact housing bearing
18 contact housing axis of rotation
20 contact bridge
22 claw-shaped mating contact receiving part
24 claw-shaped mating contact receiving part
26 stationary mating contact
28 stationary mating contact
30 spring terminal

1: A rotating contact apparatus for a switch, comprising:
a contact apparatus housing;
a contact housing;
a bearing for the contact housing, provided in the contact apparatus housing, the contact housing being mounted in the bearing so as to rotate about a rotation axis;
a contact bridge, mounted in the contact housing, which rotates with the housing and includes, at each of an end thereof, a receiving portion for one or more stationary mating contacts,
wherein the receiving portions protrude from corresponding openings in the contact housing to such an extent that the receiving portions engage with the stationary mating contacts during rotation of the contact housing,
configured such that electrical contact may be produced between the stationary mating contacts via the contact bridge,
wherein at least one spring terminal arranged between the contact housing and the contact bridge such that the contact bridge is resiliently mounted in the contact housing approximately perpendicular to a rotational plane of the contact apparatus,
wherein the contact housing is approximately cylindrical,
wherein the contact housing includes, on at least part of a lateral surface thereof, a gearwheel portion, and
wherein the contact apparatus housing includes an opening through which the gearwheel portion projects, such that the contact housing can be caused to rotationally move to open or close the contacts between the stationary mating contacts and the receiving portions using a gearwheel engaging in the gearwheel portion.

2: The rotating contact apparatus of claim 1, wherein the contact apparatus housing includes a first housing half-shell and a second housing half-shell,
wherein the bearing is formed in at least one of the two housing half-shells,
wherein at least one of the two housing half-shells includes the opening for the gearwheel portion of the contact housing on a side approximately perpendicular to the axis of rotation.

3: The rotating contact apparatus of claim 1, wherein the contact housing includes a first housing shell and a second housing shell,
wherein the housing shells are almost identically formed, and
wherein the housing shells each include plug-in connections and a bearing for the contact bridge and the at least one spring terminal for assembling the contact housing.

4: The rotating contact apparatus of claim 1, wherein the contact bridge includes an approximately rectangular shaped middle part, and
wherein a receiving portion for a stationary mating contact is provided on each short side of the middle part.

5: The rotating contact apparatus of claim 4, wherein the receiving portions for the stationary mating contacts are each configured as claw-shaped mating contact receiving parts, and
wherein the receiving portions are each aligned such that the opposing claws thereof are located on different planes that are in parallel with the rotational plane of the contact apparatus.

6: A rotary switch, comprising:
the rotating contact apparatus of claim 1.
